(19) United States
(12) Patent Application Publication
(10) Pub. No.: US 2009/0124235 A1
(43) Pub. Date: May 14, 2009

(54) METHOD OF CONFIRMING AUTHORIZED MICROCELL BASE STATION USE

(76) Inventors: Peter Bosch, New Providence, NJ (US); Hubert Rae McLellan, Summit, NJ (US); Paul A. Polakos, Marlboro, NJ (US); Louis G. Samuel, Swindon (GB); Holger Claussen, Swindon (GB); John M. Graybeal, Califon, NJ (US)

Correspondence Address: CARLSON, GASKEY & OLDS, P.C./Alcatel-Lucent, 400 W MAPLE RD, SUITE 350, BIRMINGHAM, MI, 48009, US

(21) Appl. No.: 11/938,957

(22) Filed: Nov. 13, 2007

(51) Int. Cl. H04M 1/66; H04Q 7/20

(52) U.S. Cl. 455/411; 455/444

(57) ABSTRACT

An exemplary method of confirming authorized use of a microcell base station includes determining that the microcell base station has made a connection with a mobile station. A determination is made whether the mobile station subsequently establishes a connection with a selected macrocell base station. Whether the mobile station successfully makes the connection with the selected macrocell base station is used as an indication of authorized use of the microcell base station.

### FIELD OF THE INVENTION

This invention generally relates to communication. More particularly, this invention relates to wireless communication.

### DESCRIPTION OF THE RELATED ART

Wireless communication systems are in widespread and steadily increasing use. Equipment manufacturers and service providers are constantly striving to meet the demands of consumers of wireless communication products and services.

Typical wireless communication systems include a network that facilitates wireless communications on behalf of subscribers. Base stations are geographically located to provide wireless service coverage in selected areas. Because traditional base stations provide a relatively large area of coverage, the cells associated with such base stations are sometimes referred to as macrocells. There are known limitations associated with macrocell coverage.

One proposed advance has been to allow for an overlay network of smaller cells in the same area where macrocell coverage may be provided. Such smaller cells can, for example, establish wireless coverage within a building where sufficient coverage is not available form the macrocell base station because of losses associated with signals not being able to pass through building structures, for example. This description uses the term “microcell” to refer to such smaller cells to distinguish them from traditional macrocells. The term microcell in this description is not limited intended to be strictly limited in a technical sense to any particular overlay cell configuration.

One challenge in managing the proliferation and use of microcell base station devices is to ensure that they are being used according to preset criteria. For example, a consumer may purchase a microcell base station device for use at a business or home location. A wireless system operator typically has a license to transmit in a particular frequency band. The wireless operator needs to ensure that the purchaser of the microcell base station device is using a particular frequency band according to the license granted to the wireless operator. For example, certain frequency bands are licensed in particular geographical areas. It is necessary, therefore, to ensure that microcell base station devices are only used in the appropriate frequency band within an allowable geographic area.

One challenge is how to locate microcell base station devices to ensure that they are being used in an authorized manner such as being used in an appropriate location.

Microcell base stations are often intended for indoor use. Global positioning system (GPS) location information regarding the microcell base station, therefore, will not be available in many circumstances. Additionally, including GPS support on a microcell base station will increase the cost of the device which is undesirable for many such products. Accordingly, GPS-based location solutions for microcell base station devices typically will not work.

It may be possible to include a particular backhaul technology endpoint such as a DSL or cable modem on a microcell base station. The backhaul end point of the link layer (e.g., DSL cable) ends a particular location. If a microcell base station is intimately tied to the backhaul, the use address of the microcell base station is known. There are problems associated with such an approach, however. For example, if the backhaul is provided by a different operator than the wireless service provider, then special arrangements are needed between such companies so that the backhaul information is available to the wireless service provider. This adds complexity and inconvenience.

### SUMMARY

An exemplary method of confirming authorized use of a microcell base station includes determining that the microcell base station has made a connection with a mobile station. A determination is made whether the mobile station subsequently establishes a connection with a selected macrocell base station. The determination regarding the connection with the selected macrocell base station is used as an indication of authorized use of the microcell base station.

One example includes instigating a handover of the mobile station from the microcell base station to the selected macrocell base station. If the mobile station successfully makes the instigated handover, that provides an indication of authorized use of the microcell base station.

In another example, the service area of the microcell base station does not overlap with any macrocell coverage such that instigating a handover to a selected macrocell base station is not possible. In such an example, the next subsequent connection between the mobile station and a macrocell base station is used as an indicator of authorized use of the microcell base station.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication system that is useful with an embodiment of this invention.

FIG. 2 is a flowchart diagram summarizing one example approach.

### DETAILED DESCRIPTION

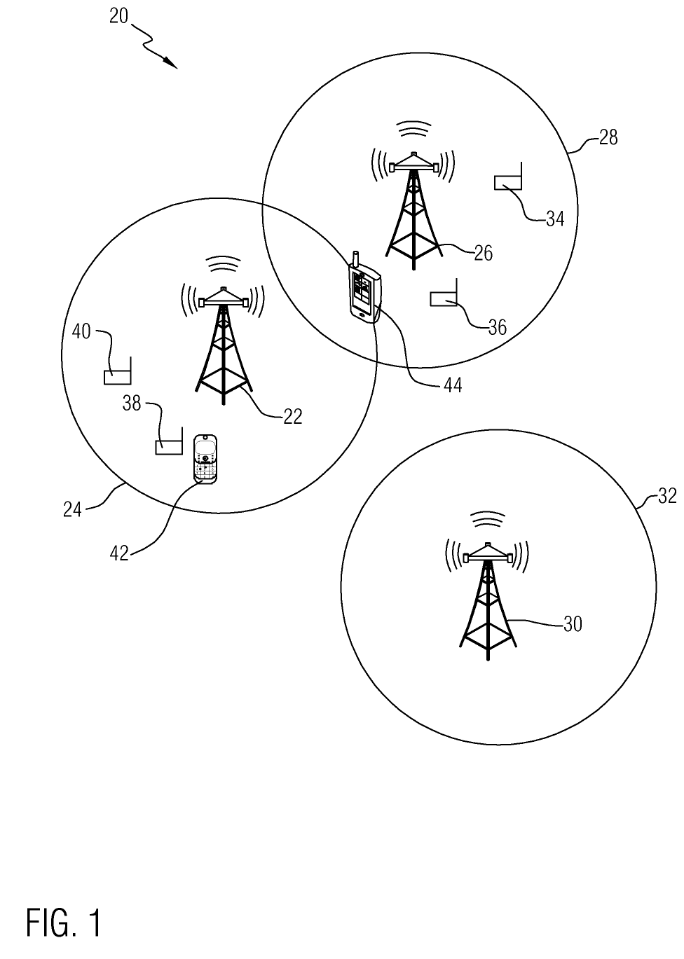

FIG. 1 schematically illustrates selected portions of a wireless communication system 20. A macrocell base station 22 provides wireless communication coverage in a macrocell coverage area schematically shown at 24. Another macrocell base station 26 provides a macrocell coverage area 28 and a macrocell base station 30 provides a macrocell coverage area schematically shown at 32. The example of FIG. 1 includes a plurality of microcell base station devices 34, 36, 38 and 40. Each of the microcell base station devices provides an area of wireless communication coverage that is smaller than that provided by the macrocell base stations. In this example, the microcell base station devices 34-40 can be considered overlay network devices while the macrocell base stations 22, 26 and 30 can be considered part of an underlay network.

This description uses the term “microcell” to refer to relatively smaller, overlay cells to distinguish them from traditional, larger underlay macrocells. The term “microcell” in this description is not intended to be strictly limited in a technical sense to any particular overlay cell configuration.

In many circumstances, the microcell base station devices will be provided to a consumer or end user with particular constraints on the use of the device. For example, the microcell base stations are limited to operating on particular frequency bands in particular locations.

In many circumstances, the purchaser or end user of a microcell base station will provide a service address where the device will be placed in use. A wireless service provider may register the address information and provide the frequency, bandwidth and power parameters for the microcell base station device based upon the service address. When the microcell base station is first placed into use, and perhaps periodically after the initial use, the service provider is able to confirm authorized use of the microcell base station by obtaining an indication of at least an approximate location of the microcell base station device.

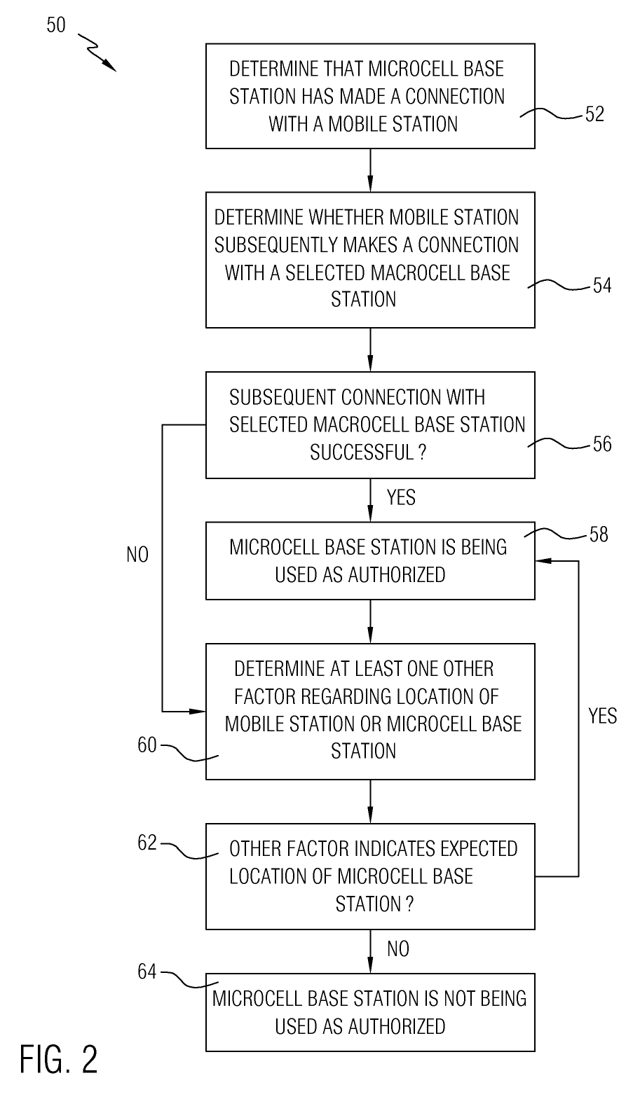

FIG. 2 includes a flowchart diagram 50 summarizing one example approach for confirming authorized use of a microcell base station. At 52, a determination is made that the microcell base station has established a connection with a mobile station. Then a determination is made whether the mobile station subsequently makes a connection with a selected macrocell base station at 54. The macrocell base station is chosen based on known locations of macrocell base stations and the authorized location of the microcell base station of interest, for example. As shown at 56, if the connection was successful, a determination is made at 58 that the microcell base station is being used as authorized. In other words, if the mobile station is able to make the expected connection with a macrocell base station, that provides an indication that the mobile station and the microcell base station are in a location that is at least approximately where the microcell base station is authorized to be used.

One example includes enabling the authorized microcell base station for further use as a result of the confirmation.

If the mobile station did not successfully make the subsequent connection, then a determination is made at 60 in the example of FIG. 2 regarding at least one other factor that can provide an indication of the location of the mobile station or the microcell base station. At 62, if the other factor indicates the expected location of the mobile station or the microcell base station, then the microcell base station is determined to be used as authorized at 58. If the other factor does not indicate the expected location, then a determination is made at 64 that the microcell base station is not being used as authorized.

One example includes disabling the microcell base station to prevent further unauthorized use responsive to a failed confirmation.

Considering the example of FIG. 1, a mobile station 42 establishes a connection with the microcell base station 38. The service provider who has license to the frequency band that the microcell base station 38 is using determines this by appropriate signaling from the microcell base station 38. Given this description, those skilled in the art will be able to configure an appropriate arrangement with a microcell base station for receiving such signaling. The service provider makes a determination of an expected service address or location for the microcell base station 38. This may be obtained from a lookup table of registered devices, for example. The service provider then makes a determination regarding a macrocell network or underlay network in the vicinity of the authorized location for the microcell base station 38. At least one macrocell base station within that area is then selected for purposes of confirming authorized use of the microcell base station 38.

In one example, the operator instigates a handover of the mobile station 42 from the microcell base station 38 to a selected macrocell base station. In the example of FIG. 1, the operator will know, for example, that that authorized location of the microcell base station 38 is within the cell coverage area 24 serviced by the macrocell base station 22. In this example, a handover of the mobile station 42 is instigated from the microcell base station 38 to the macrocell base station 22. Signaling from the microcell base station 38 to the mobile station 42 is used to instigate the handover in one example.

If the microcell base station 38 is in the expected location, the mobile station 42 should be able to successfully make the handover to the macrocell base station 22. If that occurs, this provides an indication that the microcell base station 38 is at the authorized location. Such an indication provides information for confirming authorized use of the microcell base station 38. Confirming whether the mobile station 42 establishes a connection with the macrocell base station 22 may be obtained using known signaling and information that will be available from the base station 22, for example.

If the mobile station 42 does not successfully make the handover to the macrocell base station 22, that may be an indication of unauthorized use of the microcell base station 38. Under some circumstances, however, when the microcell base station 38 is in the authorized location, a mobile station may not successfully complete a handover for other reasons. Accordingly, the example of FIG. 2 includes determining at least one other factor regarding the location of the mobile station or the microcell base station to allow for such circumstances.

One example includes requesting a measurement report from the mobile station 42. If the microcell base station 38 has wireless terminal capabilities built in, it may provide a measurement report. At least one of the devices provides a measurement report that can be used in a known manner for making a determination regarding a wireless system topology in the vicinity of the device providing the measurement report. For example, a measurement report will indicate cell identifiers, signal strengths, etc., that are usable by a service provider having information regarding devices that are in use in particular areas for determining at least an approximate location of the mobile station or microcell base station that provides the measurement report. In other words, a measurement report provides a radio topological picture that should be consistent with or correspond to an expected topology in the vicinity within which the microcell base station is authorized for use. In the context of the operator's network, the reported measurements will have some correspondence to expected measurements if the device providing the measurement is in approximately the expected, authorized location.

For example, a mobile station 44 establishes a connection with the microcell base station 36. A handover is then instigated from the microcell base station 36 to the macrocell base station 26. Assuming that handover attempt fails, the mobile station 44 can be instructed to provide its last measurement report. In the illustrated example, the mobile station 44 may detect a signal from the macrocell base station 22 because it is within the coverage area 24, for example. The service provider will have information indicating the approximate location of the base station 22 relative to the base station 26 and the coverage area 28 within which the microcell base station 36 is authorized for use. The measurement report, therefore, provides some additional information regarding the location of the mobile station 44 and the microcell base station 36 for purposes of confirming authorized use of the microcell base station device.

If the measurement report does not correspond to an expected measurement report, that is used in one example as a confirmation that the microcell base station device is not being used in an authorized location.

Even if the instigated handover fails, a measurement report that does correspond to an expected report provides an indication that the failed handover is not necessarily an indication that the microcell base station is being used in an unauthorized manner. In one example, the corresponding measurement report alone is not used for confirming authorized use of the microcell base station device but, instead, further determinations regarding an ability of the mobile station 44 to establish a connection with the surrounding macrocell network will be used to eventually confirm authorized use of the microcell base station device. In other words, a failed subsequent connection with a selected macrocell base station places the microcell base station use under suspicion if the other factor indicates possible authorized use.

Assume the microcell base station 36 was brought into the coverage area 32 and a mobile station made a connection with it. The operator or service provider will instigate a handover of the mobile station to the macrocell base station 26 because the microcell base station 36 is authorized to be used within the coverage area 28 in this example. A mobile station within the coverage area 32 will not be able to successfully complete a handover to the base station 26. Instead, only the macrocell base station 30 would be likely available for such a handover. Upon determining that the handover to the base station 26 was not completed, a measurement report from the mobile station or the microcell base station 36 would indicate that the macrocell base station 30 was in the vicinity of the microcell base station or mobile station. The network operator or service provider has information that there is no coverage overlap between the coverage provided by the macrocell base station 30 and the macrocell base station 26 and, therefore, such a measurement report is a confirmation that the inability to complete the instigated handover is a result of the microcell base station being in an unauthorized location.

In some examples, the measurement report that is requested for potential use in ruling out unauthorized use as a result of a failed handover attempt is requested just before the terminal is instructed to handover. If the terminal fails to handover, then that fact and the measurement report can be used together to establish whether the microcell base station has been improperly placed and is being used in an unauthorized manner.

In some situations, there will be no macrocell coverage in the service area of the microcell base station. In such an example, an attempt to handover to a macrocell base station will necessarily fail because there is no such coverage available. One example includes determining whether the mobile station that makes a connection with such a microcell base station subsequently makes a connection with a macrocell base station at one of a plurality of possible entry points into an area where macrocellular coverage is provided. In other words, once the mobile station leaves the microcell base station location, there are only a few likely locations within a macrocell network where that mobile station can re-establish itself in the macrocellular network.

For example, if a microcell base station device were placed in use in between the coverage areas 24, 28 and 32 but outside of all of those coverage areas at the location 70, it would be possible for a mobile station to make a connection with such a microcell base station while the mobile station is outside of the coverage areas 24, 28 and 32. Upon leaving that location, the mobile station is likely to enter one of the coverage areas 24, 28 or 32. Detecting registration of that mobile station in one of those parts of the underlay network provides an indication that the mobile station was most recently used in a vicinity outside of the coverage area where the registration occurs. One example may include using any one of the three coverage areas for the subsequent connection between the mobile station and a macrocell base station for purposes of confirming authorized use of the recently used microcell base station that is outside the coverage area of the underlay network.

One example includes forcing re-registration with the underlay network by using different location or paging area identifiers between the microcell base station and the underlay network. This re-registration in the underlay network is then used as proof of at least the approximate service address or current location of the microcell base station.

One example includes requiring periodic re-registration in the macrocellular network to demonstrate that the microcell base station is, in fact, in an expected location. This avoids the situation where an individual knowing the technique for confirming authorized use maliciously places the microcell base station in an unauthorized location, establishes a connection between it and a mobile station, turns off the mobile station and then travels to the location within the macrocell network where the re-registration is expected and only then turns the mobile station back on. Requiring periodic re-registration within the underlay network should avoid such attempts to circumvent the process for confirming authorized use of the microcell base station.

Some example microcell base stations will be used in collaboration with universal mobile access (UMA). For such situations, after the microcell base station is powered on, a UMA-capable mobile station establishes a connection through the Wireless Fidelity (WiFi) portion of the microcell base station. During this period, the cellular network portion of the microcell base station is disabled. The mobile station is then requested to measure the received power levels of the underlay or macrocellular network. Such a measurement will place the WiFi portion of the microcell base station in the cellular network. If the operator supporting the microcell base station determines that the WiFi portion of the microcell base station is at the correct location, the operator can power on the cellular portion of the microcell base station. Then the operator can instigate a handover between the mobile station and a selected base station of the macrocell network to demonstrate that the WiFi and cellular portions of the microcell base station are at the same location.

The disclosed examples provide a technique for utilizing existing underlay or macrocell network resources for confirming authorized use of a microcell base station installed as part of an overlay network arrangement or as a single overlay device. The disclosed examples do not require relying upon GPS-based solutions and do not require any significant modification of the underlay network (other than perhaps additional database information and functionality to perform the functions of the described examples).

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of confirming authorized use of a microcell base station, comprising the steps of:
determining that the microcell base station has made a connection with a mobile station; and
determining whether the mobile station has subsequently established a connection with a selected macrocell base station as an indication of authorized use of the microcell base station.

2. The method of claim 1, comprising
determining an approximate location of the microcell base station based upon a known location of the selected macrocell base station if the mobile station successfully established the connection with the selected macrocell base station.

3. The method of claim 1, comprising
determining that the microcell base station may be in use in an unauthorized manner if the mobile station does not establish a connection with the selected macrocell base station.

4. The method of claim 3, comprising
using at least one other indicator for confirming unauthorized use of the macrocell base station.

5. The method of claim 4, comprising
receiving a measurement report from at least one of the mobile station or the microcell base station indicating a topology of a wireless network in a vicinity of the one of the mobile station or the microcell base station; and
determining whether the measurement report or the indicated topology corresponds to an authorized location of the microcell base station.

6. The method of claim 5, comprising
determining that the microcell base station is in use in an unauthorized manner if the measurement report or the indication of the topology does not correspond to the expected location.

7. The method of claim 1, comprising
instigating a handover of the mobile station from the microcell base station to a selected macrocell base station; and
determining whether the instigated handover is successfully completed as the indication of authorized use of the microcell base station.

8. The method of claim 1, comprising
determining whether a next connection with a macrocell base station subsequent to the connection between the mobile station and the microcell base station is between the mobile station and a macrocell base station that is located within an expected vicinity of an authorized location for the microcell base station.

9. The method of claim 17 wherein the microcell base station has a wireless fidelity (WiFi) portion and a cellular portion and the method comprises
determining that the mobile station has established a connection with the WiFi portion of the microcell base station while the cellular portion is disabled;
obtaining a measurement report as an indication of a location of the microcell base station;
selectively enabling the cellular portion of the microcell base station responsive to determining that the location corresponds to an authorized location.

10. The method of claim 9, comprising
instigating a handover of the mobile station from the microcell base station to the selected macrocell base station; and
determining whether the instigated handover is successful as an indication of co-location of the WiFi portion and the cellular portion.
